(19) United States
(12) Patent Application Publication
(10) Pub. No.: US 2010/0061410 A1
(43) Pub. Date: Mar. 11, 2010

(54) System and method for controlling nonlinearities in laser units

(76) Inventors: Nikolai Platonov, Worcester, MA (US); Alex Yusim, Boston, MA (US); Oleg Shkurikhin, Shrewsbury, MA (US); Anton Drozhzhin, Farmington, CT (US)

Correspondence Address: IPG PHOTONICS CORPORATION, 50 OLD WEBSTER ROAD, OXFORD, MA, 01540, US

(21) Appl. No.: 12/283,309

(22) Filed: Sep. 11, 2008

(51) Int. Cl. H01S 3/10; G02B 6/00; G02B 6/32

(52) U.S. Cl. 372/21; 385/122; 385/33

(57) ABSTRACT

An optical system includes a launching component radiating a beam of light at a fixed power, a specialty component, which receives the beam and is configured with a transverse mode field diameter different from that one of the launching component, and a focusing component substantially losslessly coupled to the launching and receiving components. The focusing component is configured so that the effective area of mode at the input of the receiving component determines the intensity of light inducing at least one nonlinear effect at the desired threshold.

### BACKGROUND OF THE DISCLOSURE

1. Field of the Disclosure

This disclosure relates generally to an optical device configured with a GRIN fiber optic lens which couples launching and receiving optical components with different mode field diameters. In particular, the disclosure relates to an optical device configured so as to control the effective area and, therefore, intensity of light coupled into a receiving component for originating the nonlinearities of interest at the desired level.

2. Discussion of the Related Art

Normally light waves or photons transmitted through a fiber have little interaction with each other, and are only changed by their passage through the fiber in a linear manner through the process of absorption and scattering. However, there are exceptions arising from the interactions between light waves and the material transmitting them, which can affect optical signals. These processes generally are called nonlinear effects because their strength typically depends on the square (or some higher power) of the amplitude of the electric field rather than simply on the amplitude of light present. As a result, the total polarization P induced by electric dipoles is not linear in the electric field E, but satisfies the following well known general relationship

P=ε₀( [symbol] ^{(1)E}+ [symbol] ^{(2):EE}+ [symbol] ^{(3):EEE}+ . . . )¹

¹G. P. Agrawal, NONLINEAR FIBER OPTICS, third edition, p. 17

where ε₀ is the vacuum permittivity and [symbol] ^{(j)}(j=1, 2, . . . ) is jth order susceptibility. The [symbol] ⁽¹⁾ is the linear susceptibility. The second-order susceptibility x⁽²⁾ while being equal to zero in fibers, still can be responsible for such nonlinear effects as second harmonic generation provided that certain known conditions are met or a crystal is used instead of fiber. Due to the symmetry of glass on a molecular level, the main nonlinear effects correspond to the third-order susceptibility including, but not limited to, stimulated Brillouin scattering (SBS), stimulated Raman scattering (SRS), self-phase modulation and others. Each subsequent order is responsible for other nonlinear effects. As well known, all nonlinear effects are dependent upon the intensity of the electromagnetic field in the medium. Some of nonlinear effects are particularly important in optical fibers, as will be discussed hereinbelow.

While single-mode (SM) standard fiber cores are desirable for eliminating modal dispersion along a fiber link including launching and receiving fibers, the small cores become obstacles for scaling up the output powers of lasers and amplifiers. Small cores can lead to pronounced nonlinear Brillouin and Raman scattering in fiber lasers because the thresholds for such stimulated processes are generally inversely proportional to the effective mode areas. Fibers with large cores, however, tend to operate with multiple spatial modes. These characteristics present a significant problem because a good beam quality is required for many high-power applications, and much effort has gone into the development of high-beam-quality, high-power fiber devices.

The above-discussed structural differences between SM and MM fibers have been somewhat reconciled by the use of specialty fibers. Broadly, specialty fibers are optical fibers with relatively large or small mode areas and a single transverse mode or only a few modes. Furthermore, true to its name, specialty fibers are configured so as to meet specific needs. For example, there are specialty fibers configured so as to exploit nonlinearities in fiber devices and particularly high-power fiber devices associated with high optical intensities.

The optical nonlinearities are the essential parameter in certain applications of optical devices and, thus, need to be controlled. In some instances a threshold for the nonlinearities should be augmented, still in others suppressed. The specialty fibers are, thus, very different from standard single mode fibers because the specialty fibers are used specifically to exploit nonlinearities.

The use of specialty fibers in a multi-component optical device also entails a problem of mode-matching between a launching component and receiving specialty fiber of a fiber link. A mismatch leads to misalignment of the optical components, loss of power due coupling losses and unsatisfactory overall performance of the multi-component optical device. This problem has been dealt with in U.S. Pat. No. 7,340,138 ('138) disclosing a coupling waveguide between a launching SM fiber and a specialty SM receiving fiber such as a large mode area (LMA) fiber. The disclosed GRIN fiber lens fused to the opposing ends of the respective launching and receiving fibers substantially minimizes the coupling losses.

However, the US '138 neither exploits nonlinearities nor discloses a means for adjusting the parameters of fiber components so as to meet the desired threshold for a particular nonlinearity in a receiving component. Once the mode matching is achieved, the device of U.S. '138 is completed. Yet, achieving the satisfactory modematching does not mean that any of nonlinearities are originated at the desired level. In fact, the opposite is quite common: the desired level of nonlinearities is not reached although the coupling of fibers is substantially lossless.

U.S. Pat. No. 6,839,483 (US '483) discloses a multi-component optical link or device having a GRIN lens which is fused to launching and receiving components. This reference is exclusively concerned about the minimization of coupling losses between components having fundamental modes of different size. If one of ordinary skills attempted to configure an apparatus operative to have the nonlinearities of interest at the required level based on US '483, one would fail since this patent, like U.S. '138, does not provide any teaching of how to do it.

U.S. Pat. No. 4,701,101 (US '101) discloses a non-monolithic fiber link provided with a GRIN lens which is configured to substantially losslessly couple launching and receiving fiber components having modes of different size. The US '101, like US '138 and US '483, does not disclose controlling an effective area of the intensity of the mode and, therefore, intensity of light coupled into the receiving component so as to originate the nonlinearities of interest at the required threshold. Yet, as discussed above, such an adjustment is often critical for certain types of optical devices used in appropriate applications.

A need, therefore, exists for a multi-component optical device configured so as to control nonlinearities in a specialty receiving fiber.

### SUMMARY OF THE DISCLOSURE

This need is met by an optical device configured in accordance with the present disclosure. The disclosed device generally includes launching and receiving components having different transverse mode field distributions, and a predetermined length of graded index (GRIN) lens component having its opposite ends coupled to respective launching and receiving components. In contrast to the known prior art, the disclosed device is operative to provide for the nonlinearities of interest at the desired level in the specialty fiber while minimizing coupling losses as light propagates along the coupled components of the device. The disclosed device and techniques allow for the optimization of the nonlinearities by selectively adjusting the physical and geometrical parameters of the components of the disclosed device.

In accordance with of the disclosure, an optical device is configured with launching and receiving components having different mode field diameters. The device further includes a focusing component, such as a GRIN lens, coupled substantially losslessly to the opposing ends of the respective launching and receiving components. The GRIN lens is configured so that an effective area of the intensity of the mode (referred hereafter as “the effective area of the mode) is adjusted so as to have the intensity of light coupled into the receiving component cause the origination of the nonlinear effect of interest at the desired threshold. As readily understood by one of ordinary skills in the laser arts, the smaller the effective area of the mode, the higher the intensity of light coupled into the core of the receiving component, the higher nonlinearities in this component, and conversely, the lower the intensity, the lower the nonlinearities. The device can operate in accordance with multiple techniques for controllably adjusting an effective area of the intensity of the mode supported by the GRIN lens' core and, thus, intensity of light coupled into the receiving component in order to originate the nonlinearity of interest therein at the desired threshold.

One of the techniques includes controllably altering the diameter of the core of the GRIN lens. Thus, the disclosed device operating in accordance with this technique is configured with a light launching component has the geometry having a mode field diameter (MFD) different from that one of a light receiving component which is optically coupled to the launching component. To substantially losslessly transform the MFD of the launching component into the MFD of the receiving component, the disclosed device further includes the predetermined length of the focusing component including at least one graded index lens (GRIN). The variation of the mode field area relates to the effective area Aeff of the mode in the receiving component. The effective area means the overlap between the area of the mode and the area of the core in the receiving component. Changing the parameters of the GRIN lens so that the mode field area increases at the output of the GRIN lens necessitates the increase of the effective area in the receiving component and, therefore, lowering the intensity. And, conversely, modifying the parameters of the GRIN so as to decrease the mode field area leads to the decreased effective area and, as a consequence, the increased intensity. The modification of the mode field area at the output of the GRIN lens may be realized by the following techniques.

One of the techniques includes controllable modification of the size of the core of the GRIN lens. Skipping intermediate steps disclosed in the previous paragraph, the larger the core diameter of the GRIN lens, the larger the effective area of the mode, the smaller the intensity of light coupled into the receiving component. The lower the intensity of light coupled into the receiving component, the lower the nonlinearities (or the higher the threshold for the latter). Conversely, the smaller the core diameter of the GRIN component, the smaller the effective area, the higher the intensity of light coupled into the receiving component, the higher nonlinearities (or the lower the threshold) in the receiving fiber. In case of the fiber receiving component, when the mode field area at the output of the GRIN lens is changed, the mode field area in the receiving component should be changed as well in order to have the desired effective area therein and, therefore the desired intensity. There is no modification needed, if the receiving component is crystal.

The other technique for changing the mode field area at the output of the GRIN lens provides for controllably altering a refractive index of the core of GRIN lens so as to increase or decrease the numerical aperture (NA) of the latter. Accordingly, the disclosed device includes launching, transmitting and focusing components, as discussed previously. The GRIN lens of the focusing component is configured with a NA adjusted so that the effective area of the mode in the receiving component and, thus, the intensity of the light coupled into the receiving component are determined to provide for the desired threshold for nonlinearities. In particular, the greater the NA of the GRIN lens, the lower the effective area Aeff of the mode in the receiving component. The lower the effective area, the higher the intensity coupled into the receiving fiber, the lower the threshold for nonlinearities in the receiving fiber. Conversely, the smaller the NA of the GRIN lens, the higher the effective area of the mode, the lower the intensity of light, and the higher the threshold for nonlinearities in the receiving component once the latter has been modified to have its MFD match the MFD at the output of the GRIN lens.

In accordance with a further technique, the optical intensity of light beam propagating along an optical link, which includes launching, focusing and receiving components, can be altered by modifying the wavelength of the beam. The longer the wavelength, the higher the effective area of the mode in the receiving fiber, the smaller the intensity of light coupled into the receiving component, and the smaller the nonlinearities. Conversely, the shorter the wavelength, the lower the desired threshold for nonlinearities (higher nonlinearities) in the receiving component.

A further technique allowing for controllably modifying the effective area of the mode in the receiving fiber and, therefore, the intensity of light coupled into the receiving component includes configuring the GRIN lens with the predetermined desired refractive index profile. The refractive index profile may be selected to have a parabolic profile or a non-parabolic profile. Modifying the refractive index profile of the GRIN lens can directly affect the effective area of the mode and, thus, a threshold for selected nonlinearities in the receiving component.

The further aspect is concerned with the practical applications of the disclosed device. Utilizing the disclosed focusing component which is specifically configured with the desired effective area of the mode supported by the core of the focusing component, the disclosed device may be used in a variety of application requiring the origination of one or more nonlinear effects of interest at the desired threshold.

For example, in accordance with one of numerous applications of the disclosed device, the latter is utilized in a fiber Raman laser that often requires lowering the desired threshold for the stimulated Raman scattering (SRS). Accordingly, the device used for this application is configured with a rare-earth doped active fiber laser which either functions as a launching component or is coupled to the launching component. The device further is configured with a receiving component having an MFD different from that one of the launching component, and focusing component with at least one GRIN fiber lens substantially losslessly coupling the launching and receiving components. The GRIN lens is configured such the area of the mode field at its output that the intensity of light coupled into the receiving component is sufficient to originate the SRS at the desired threshold thereof. In particular, the receiving fiber is configured as a specialty fiber, such as, without any limitations, a highly nonlinear fiber (HNLF). This type of specialty fibers is specifically designed with smaller MFD than that one of the output fiber of a rare-earth doped fiber laser. In use, the focusing component, such as GRIN lens, and receiving component are so adjusted that the SRS may controllably originate in the receiving component at a progressively lower threshold.

Another application, where a threshold for nonlinearities should be preferably lowered, is associated with supercontinuum generation (SCG)—a method for generating a broadband source often referred to as a white light source. The SCG is based on non-linear effects to spectrally broaden out a light. One of these nonlinear effects is four wave mixing (FWM), whereas the other nonlinear effect is self-phase modulation allowing for the change of absorption and beam properties.

Other practical applications require raising (or suppressing) the desired threshold for nonlinearities. Thus in accordance with a further application, the disclosed device is configured as a single frequency fiber laser including a plurality of amplifying stages. In contrast to the previously disclosed embodiment where the disclosed device is configured to lower the threshold for nonlinearities, here the opposite is true: a GRIN lens is configured to controllably decrease the intensity of light at the input of the receiving component in order to augment a threshold for nonlinearities therein. Configured with the same components as the device for suppressing a threshold for nonlinearities, the receiving component of this device is configured from a large mode area (LMA) fiber.

### BRIEF DESCRIPTION OF THE DRAWINGS

The above and other features of the disclosed device will become more readily apparent from the specific description accompanied by the following drawings, in which:

FIGS. 1A and 1B are respective diagrammatic views of a device configured in accordance with the disclosure.

FIG. 2 illustrates propagation of a Gaussian beam through a square-law medium.

FIG. 3 is a graph illustrating the change of output mode field diameter and intensity of light at the receiving component plotted against the core diameter of a focusing component.

FIG. 4 is a graph illustrating the change of output mode field diameter and intensity at a receiving components plotted against the numerical aperture (NA) of a focusing component.

FIG. 5 is a flow chart illustrating a method of using the device of FIGS. 3A & 3B.

FIG. 6 is a diagrammatic view of a first embodiment of the disclosed device.

FIG. 7 is a diagrammatic view of a second embodiment of the disclosed device.

FIG. 8 is a diagrammatic view of a third embodiment of the disclosed device.

FIG. 9 a diagrammatic view of a fourth embodiment of the disclosed device.

FIG. 10 a diagrammatic view of a fifth embodiment of the disclosed device.

FIG. 11A is a diagrammatic view of the sixth embodiment of the disclosed device.

FIG. 11B is a diagrammatic view of the modified device of FIG. 11A.

FIG. 12 is a diagrammatic view of a seventh embodiment of the disclosed device.

FIG. 13 is a further embodiment of the disclosed device provided with a spacer fused between focusing and receiving components.

### SPECIFIC DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. Within the context of this disclosure only, the term “mode field” means the radial power distribution across the core of a fiber component, while the term “mode field diameter (MFD) means the measure of the radial power distribution at the 1/e²(≈13.5%) level from the peak thereof. The term “effective area” means the overlap between the area of the mode field in a light receiving component and the area of the core thereof. Finally, the intensity of light is defined as the total power of the light beam divided by the effective area. The word “couple” and similar terms do not necessarily denote direct and immediate connections, but also include connections through intermediate elements or devices.

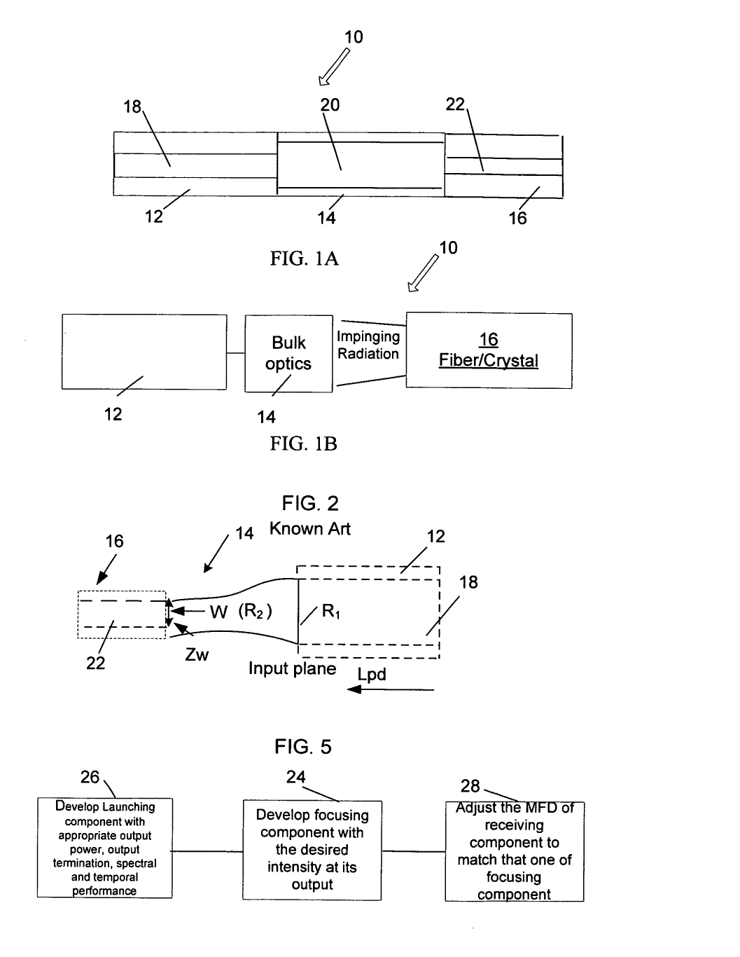

FIGS. 1A and 1B illustrate an optical system or device 10 which is configured in accordance with the disclosure and operative to controllably provide for the desired threshold for selected nonlinearities in a specialty receiving optical component 16. The device 10 is further configured with a light launching optical component 12, and a focusing component including a graded index (GRIN) lens 14 which is coupled to opposing ends of respective launching and receiving components 12 and 16. In accordance with the basic concept of the disclosure, the desired threshold for nonlinearities in receiving component 16 can be reached by controllably modifying physical parameters of the focusing and receiving components. The GRIN lens 14 may be made from a single-mode or multimode fiber, as shown in FIG. 1A, or a bulk optical component, as illustrated in FIG. 1B.

In operation, launching component 12, such as a single mode fiber, radiates an optical signal coupled into receiving component 16, which can be a specialty fiber or crystal. The cores 18 and 22 of respective launching 12 and receiving 16 components are further configured with different mode field diameters. The difference between the mode field diameters leads to a significant amount of coupling losses. To prevent substantial coupling losses, a predetermined length of the focusing component, such as GRIN fiber lens 14, has a core 20, which is configured to substantially losslessly couple the output and input ends of the respective launching and receiving components together. Accordingly, the mode field at the input of GRIN lens 14 has substantially the same MFD as the MFD of the field at the output of launching component 12, whereas the MFD at the output end of GRIN lens 14 substantially corresponds to the MFD at the input of receiving component 16. The substantially lossless coupling equally relates to GRIN lens 14 made from a bulk optical component and coupled to other components of the disclosed device by well known mechanical methods or fusion spliced methods. As a matter of convenience, the following description relates to an all fiber system including a GRIN fiber lens, but, as readily realized by one of ordinary skills, can be fully applied to a GRIN lens made from bulk optics.

The specialty receiving component 16 has the mode field which can be smaller or larger than that one of standard fibers. The intensity of mode is determined in accordance with the following:

$$I ≡ \frac{P}{Aeff}$$

wherein A is an effective area, and P is a total power of light beam within this area. Since the field in single mode fibers is not evenly distributed or even fully contained within the core, the effective area parameter, Aeff, is defined for the purposes of calculating nonlinear effects. It is a single value, based on the modal field distribution and used to calculate a value for the optical intensity in accordance with the following:

$$Aeff = \frac{2 π ( \int I ( r ) r d r )}{\int I ( r ) r d r}$$

where I(r) is the intensity of the near-field of the fundamental mode at radius r from the axis of the fiber. In other words within the scope of this disclosure, the effective area Aeff is the overlap between the mode field area coupled into the receiving component 16 and the area of the core of the receiving component. Thus, in accordance with the inventive aspect, controllably changing the parameters of focusing component 14 indirectly affects the effective area Aeff of the mode in the receiving component 16 and, therefore, may either raise or lower a desired threshold for nonlinearities in receiving component 16 of device 10 for a given total power P.

If the MFDs of the respective launching and receiving components are not substantially different from one another, the single GRIN lens 14 can be used and structured so as to induce a nonlinear effect(s) at the desire threshold. For example, single GRIN lens 14 transforming a mode field from a 14 micron launching component to a 10 micron receiving component may be adequate. Often, however, receiving component 16 has an MFD substantially differing from that one of the launching component. In this case, preferably, but not necessarily, multiple, sequentially coupled to one another GRIN lenses are so configured that the effective area at the input of the receiving component induces the selected nonlinear effect or effects at the desired threshold. Accordingly, the GRIN lenses each can have one or multiplicity of its parameters altered to either gradually increase or gradually decrease the MFD. Other configuration of the focusing component is disclosed hereinbelow in reference to FIG. 13.

FIG. 2 illustrates propagation of a Gaussian beam through GRIN lens 14 which preferably, but not necessarily, has a parabolic profile of the refractive index. As light propagates along GRIN fiber 14, the mode field periodically changes from small to large to small again and so on. The broadest region R₁ and narrowest waists R₂ correspond to respective planar wavefronts representing the largest and smallest MFDs, respectively. The planar wavefronts, as known, are best suited for fusion spicing with other fibers. The fusion splicing provides for potentially low backreflection, compactness, automatic and permanent alignment, and the absence of exposed optical surfaces that can be contaminated or damaged, especially by high optical power densities.

One of the characteristics of GRIN lens 14 is a size R₂. The parameter of interest is a location “z_{w}” of waist “w” relative to the input plane of light signal into GRIN lens 14 or the distance between the flat wavefronts, which is determinable based on the square-law analysis of Kishimoto and Koyama² and Emkey and Jack³ all fully incorporated herein by reference. The teaching of the incorporated references each teaching a combination of launching, GRIN focusing and receiving components, thus, precedes the teaching of the prior art discussed in the background of this disclosure. ² “Coupling Characteristics Between SM Fiber and Square Law Medium”, IEEE, Vol. MTT-30, No. 6, June 1982.³ “Analysis and Evaluation of Graded-Index Fiber-Lenses”, Journal of Lightwave Technology, Vol. LT-5, NO. 9, September 1987.

The size of a waist “w” at the output of GRIN lens 14 affects the intensity of light coupled into receiving component 16 and, thus, may be controllably altered. The wider the waist “w”, the greater the effective area in receiving component 16, the lower the intensity of light coupleable into receiving component 16. As a consequence, the threshold for nonlinearities is augmented or raised. The determination of the size of the waist is likewise based on the teachings of the respective incorporated references. Accordingly, the size of the waist “w” leads to the desired intensity of light in the receiving component and, therefore, to the desired threshold for the nonlinearities in question.

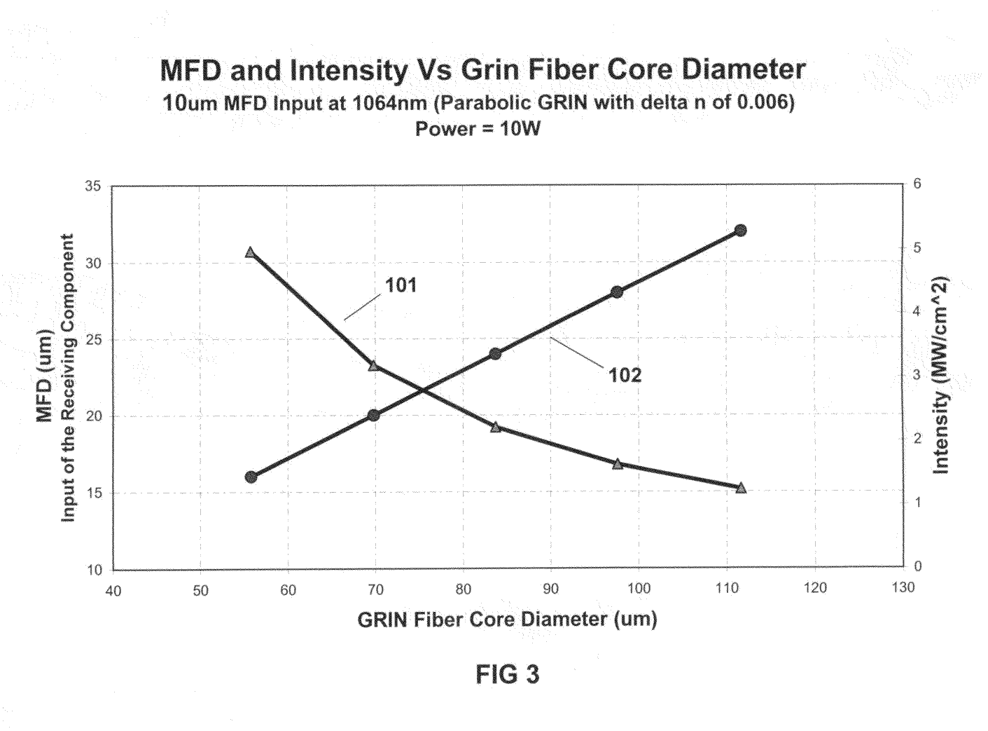

In accordance with one technique illustrated in FIG. 3 and assuming that the GRIN lens has the appropriate distance between the flat wavefronts, the core diameter of GRIN lens 14 is controllably changed to provide for such intensity 102 of light at the input of receiving component 16 that this intensity is sufficient to originate the nonlinear effect of interest at the desired threshold.

The increased core diameter of GRIN lens 14 causes the effective area in the receiving component and MFD 101 to increase after the adjustment of the core of receiving component 16. The greater the core diameter of the GRIN lens, the greater the effective area in the receiving component, the weaker the intensity 102 therein. Accordingly, the increase of the core diameter of GRIN lens 14 lessens selected nonlinear effects in receiving component 16. In other words, the increased core diameter of GRIN lens 14 indirectly suppresses the threshold for nonlinearities in specialty receiving component 16. Conversely, the decreased core diameter of GRIN lens 14 leads to the decreased effective area in receiving component 16 and, therefore, the higher intensity of light coupled into the receiving component. Accordingly, the decreased core diameter of GRIN lens 14 translates into the higher threshold for nonlinearities in specialty component 16. In the example shown in this figured, device operates with a 10 μm MFD inputted into GRIN lens 14 at a wavelength of 1064 nm and a constant relative refractive-index Δn=n_{max core}−n_{clad}=0.006.

The other technique for controllably altering the effective area Aeff in receiving component 16 is based on controllably modifying a relative refractive-index difference A between core 20 of GRIN lens 14 (FIG. 1A) and its cladding. In other words, by changing the numerical aperture, which is determined as

NA=\sqrt{n_{core}²−n_{cladding}²}

the effective area and, therefore, intensity of light 104 at the input of receiving component 16 leading to the desired threshold for nonlinearities therein can be appropriately determined. The modification of the numerical aperture is realized by increasing or decreasing the concentration of dopants, such as germanium or others, in core 20 of GRIN lens 14.

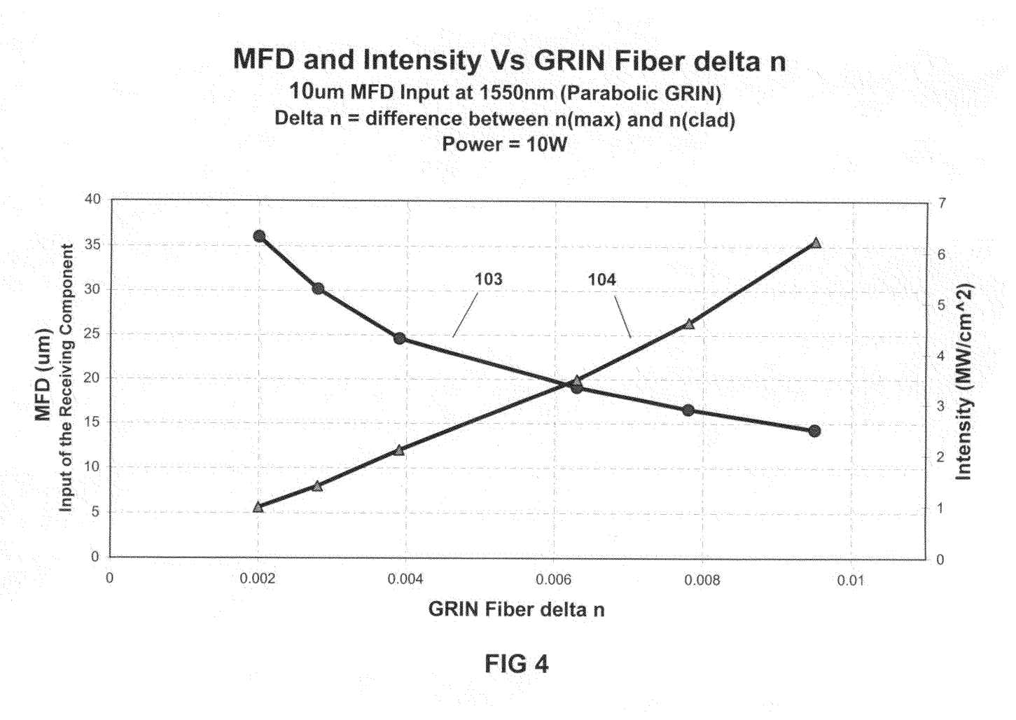

In particular, FIG. 4 illustrates the dependence of MFD 103 within GRIN fiber 14 from the numerical aperture of GRIN lens 14. According to the graph, the greater the relative refractive index difference Δ or the NA of GRIN lens 14, the lower the MFD 103 at the output of GRIN lens 14. Thus, with the increase of the NA of GRIN lens 14, the effective area in receiving component 16 decreases and, therefore, the intensity of light 104 coupled into receiving component 16 increases. In summary, the greater the NA of GRIN lens 14, the lower the threshold for the nonlinearities of interest in the receiving component. Conversely, increasing the NA of GRIN lens 14 leads to the increased threshold for nonlinearities and, therefore, the suppression of nonlinearities in receiving component 16. In this experiment, device 10 operates with a 10 μm MFD inputted into GRIN lens 14 at a wavelength of 1550 nm.

A further technique for altering the effective area of the mode in receiving component 16 includes controllably altering the wavelength of light propagating through GRIN lens 14. Based on the teaching of the incorporated references, the effective area Aeff in receiving component 16 increases with the longer wavelength, and decreases with shorter wavelengths. Accordingly, the intensity of light at the input of receiving component 16 may be decreased by selecting a longer wavelength and, conversely, increased by selecting shorter wavelengths.

FIG. 5, in combination with FIGS. 1A, 1B and 2, generally represents a process for adjusting the parameters of the components of device 10 so as to establish the desired threshold for nonlinearities in specialty receiving component 16. The GRIN lens 14 is developed in step 24 so as to achieve the appropriate effective area of the mode in receiving component 16 by sizing waist “w” under certain known conditions, such as a power of light radiated by launching component 12. The effective area of the mode in receiving component 16 allows for determination of the desired intensity of light coupled into receiving component 16, which has a known coefficient of nonlinearity n₂ based on the susceptibility of material, and therefore the desired threshold for the specific nonlinearity therein. In summary, the techniques leading to the desired threshold for nonlinearities in receiving component 16 includes adjusting the diameter of core 20 of GRIN lens 14, and/or the NA of the GRIN lens, and the wavelength at which light beam propagates through the GRIN lens.

Before or after GRIN lens 14 is developed in accordance with a mathematical model as disclosed in the above mentioned and incorporated references, launching component 12 is developed in step 26 so as to have the desired output power, output termination, spectral performance and temporal performance. Finally, receiving component 16 is configured in step 28 so as to have its core adjusted so that the mode field of the receiving component matches that one GRIN lens 14. The device is then tested to measure the effective area Aeff of the mode and, thus, a threshold for the nonlinearities of interest. The technique used for measuring the effective area may include, among others, the direct far-field, near-field scanning, variable aperture in the far field, and transverse offset. If the measured effective area and, thus, the intensity of light coupled into receiving component 16 are such that the nonlinearities of interest are originated at the desired threshold, the process is completed. Otherwise, the focusing component, such as GRIN lens 14, is redeveloped based on the teaching of the incorporated references so as to have its parameters altered to originate the nonlinear effects of interest at the desired threshold in receiving component 16.

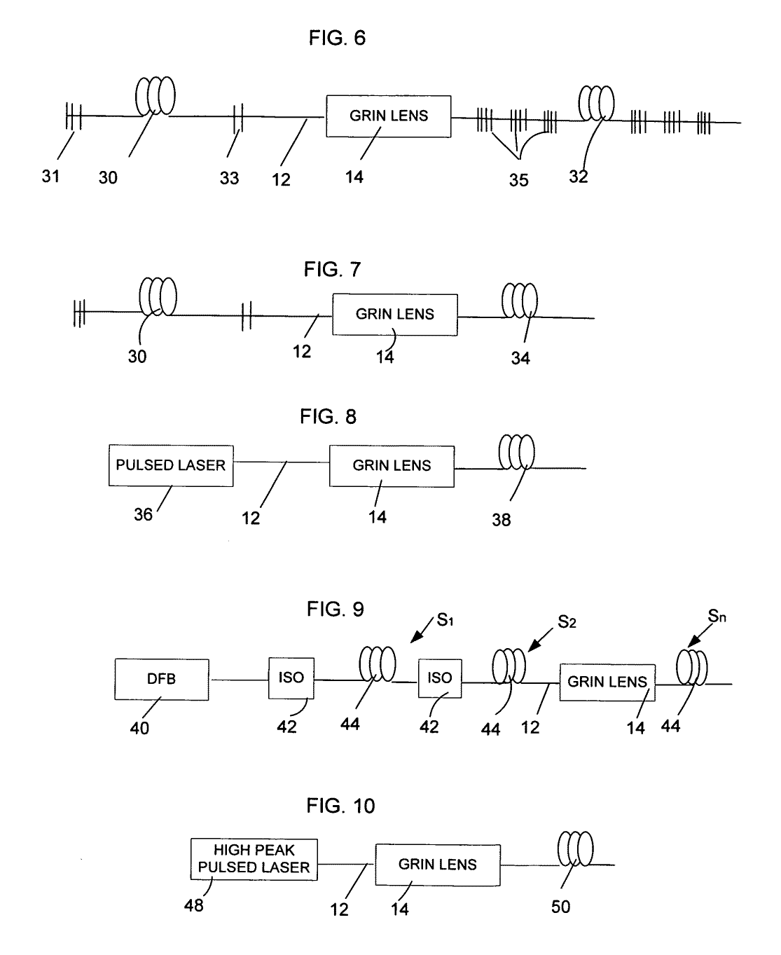

FIG. 6 illustrates one of exemplary embodiments of the above-disclosed process and device. In particular, the above-disclosed concept is applied to a Raman laser device in order to augment the nonlinear effects such as the stimulated Raman scattering in the receiving component.

Stimulated Raman scattering (SRS) occurs when light waves interact with molecular vibrations called phonons in the material. In simple Raman scattering, the molecule absorbs the light, then quickly re-emits a photon with energy equal to the original photon through virtual energy levels, plus or minus the energy of a molecular vibration mode. This has the effect of both scattering light and shifting its wavelength towards longer wavelengths.

The device is most commonly configured with a Fabry-Perot laser including a rare-earth element doped active fiber 30 with strong and weak fiber Bragg gratings 31 and 33 respectively. The output of the laser is configured with SM launching fiber 12 having a known MFD, for example 7 or 18 μm, a passive Raman fiber which is configured from an HNL fiber 32 with a small MFD of, for example, 3 μm. The Raman fiber, as known, may have multiple fiber gratings 35 located upstream and downstream from a pigtailed HNL 32 to form a cascaded Raman resonator.

The transition between the MFD of launching fiber 12 and the MFD of HNL fiber 32 is realized by at least one MM GRIN fiber lens 14 of a specifically determined length. In order to have a well pronounced Raman effect, GRIN lens 14 is specifically configured so that the intensity of light coupled into receiving HNL fiber 32 is sufficiently high to reach the threshold for the articulated Raman nonlinear effect. Thus, the use of the GRIN lens configured in accordance with the disclosure allows for augmenting nonlinearities, i.e., lowering the desired threshold for the SRS effect in the receiving HNL fiber which is extremely useful in fiber Raman lasers and amplifiers.

The HNL fibers are specialty fibers characterized by a small mode field and high nonlinear coefficient n₂, the parameter which depends upon the susceptibility of material used for manufacturing this type of fibers. The HNL fiber 32 may be selected from the groups consisting of step index fibers, those fibers which are estimated to have a step index and photonic crystal fibers. Once the configuration of GRIN lens 14 allows for the desired intensity level, receiving HNL fiber 32 may be modified to have its MFD match with the MFD at the output of GRIN lens 14. The single mode HNL component 32 may have a modified MFD to prevent forbidden power losses upon its coupling to GRIN lens 14. The modification of the MFD depends on a concrete HNL fiber used in the disclosed device. For example, if HNL fiber is configured with a step index profile of refractive index, either the core or NA of this fiber is to be adjusted. If HNL fiber 32 is configured as a photonic crystal fiber, defined only for the purpose of this disclosure as fiber configurations capable of stripping higher mode and generally having an arrangement of small air holes, then the modification of hole concentration, size and other geometrical parameters may lead to the desired MFD. So far, the discussed HNL fibers have been directed to silica based fibers with a certain nonlinear coefficient n₂. However, the MFD of receiving component 32 may be also modified by utilizing other than silica host materials with respective nonlinear coefficients. Such host materials, without any limitation and given only as an example, may include bismuth-based, telluride-based and fluoride-based fibers. Note that GRIN lens 14 is shown outside a cavity defined between FBGs 31, but can be provided inside the cavity. Similarly, GRIN lens 14 may be located between gratings 35 of Raman (HNL) fiber.

While launching component 12 is a single mode fiber, receiving HNL Raman fiber 16 can be either a SM fiber or MM fiber for a wavelength of light radiated by the SM launching fiber. As readily realized by one of ordinary skills, if a wavelength of launched optical signal is longer than a cutoff wavelength of HNL fiber 32, than the latter the core of fiber 32 supports only a fundamental mode. If, however, a wavelength of launched optical signal is smaller than a cutoff wavelength of HNL fiber 32, multiple modes may be supported by the core of HNL fiber 32. Accordingly, arranging fiber gratings 35 so that the wavelength of the launched signal is gradually changing to eventually become shorter than the known cutoff wavelength of the Raman fiber provides for the propagation of multiple modes MM in the core of HNL fiber 32. Alternatively, HNL fiber 32 may be configured with a MM core capable of supporting a single mode.

FIGS. 7 and 8 illustrate other exemplary embodiments of the disclosed device capable of controllably changing the parameters of the focusing component so as to adjust the effective area of the mode in the receiving component, and as a result, to regulate nonlinearities, such as the supercontinuum generation (SCG) therein. The SCG is a method for generating a broadband source often referred to as a white light source which is operative to broaden the light spectrally. Among multiple nonlinear effects associated with the SCG effect, four-wave mixing (FWM) and self-phase modulation are of particular interest because they allow for the spectrum broadening of the launched light.

FIG. 7 illustrates one of the modifications of the disclosed device operative to augment such a nonlinear effect as FWM which is typically associated with the continuous wave configuration of fiber lasers and amplifiers and often originated in combination with SRS. The FWM effect is originated when three wavelengths interact to generate a fourth nonlinear interaction. The idea is that two or more waves combine to generate waves at a different frequency that is the sum (or difference) of the signals that are mixed.

Importantly, FWM, like SRS, can be exploited by controllably modifying parameters of the focusing component so as to decrease the effective area of mode in a receiving component 34 and, thus, increase the intensity of light and nonlinear effects of interest therein. Accordingly, the disclosed device in FIG. 7 includes a rare-earth doped laser or amplifier 30 generating a very high power. In contrast to the device illustrated in FIG. 6, a receiving fiber 34 is free from fiber Bragg gratings. Similarly to the device of FIG. 6, receiving fiber 34 is made from HNL fibers having a mode field substantially smaller than that one of launching fiber 12 spliced to the output of laser 30. To actually have the combination of SRS and FWM nonlinear effects at the desired lower level in receiving fiber 34, GRIN lens 14, configured with such a core diameter that receiving component 34 is so adjusted that the effective area and, thus, intensity cause the nonlinear effects at the desired threshold. The HNL fiber 34 can be selected from specialty fibers to have a step index profile, those fibers that are estimated to have a step index profile, photonic crystal, photonic band gap fibers and others which are already developed and which will be developed in the future.

FIG. 8 illustrates the disclosed device associated with the self-phase modulation nonlinear effect which, like SRS and FWM, desirably originates at rather low thresholds. As known, the refractive index of glass varies slightly with the intensity of the light passing through it, so changes in the signal intensity cause a change in the speed of light passing through the glass. This process causes intensity modulation of an optical channel to modulate the phase of the optical channel that creates it. Hence, this nonlinear effect is called self-phase modulation (SPM). As the optical power rises and falls, these phase shifts also effectively shift the frequencies of some of the light. In contrast to the SRS effect in which the frequencies of light tend to shift towards longer wavelengths, FWM and SPM are associated with frequencies tending to shift in opposite directions so as to affect both the rising and falling parts of the pulse. The overall result is to substantially uniformly spread the bandwidth of the optical channel by an amount that depends on the rate of change in optical intensity as well as on the nonlinear coefficient n₂ of the fiber material.

The self-phase nonlinear effect is often associated with pulsed lasers. In fact, both the FWM and SPM nonlinear effects can be effectively used in pulsed lasers for generating supercontinuum generation (SCG). Typically, it is much easier to generate supercontinuum with high peak powers.

Therefore, the device shown in FIG. 8 is configured with a pulsed laser 36 of any configuration including, but not limited to, femtosecond, nanosecond or picosecond-configured lasers. The use of pulsed laser facilitates the generation of SCG because of much higher peak powers. The device is further configured with a HNL receiving fiber 38 designed with a mode field substantially smaller than that one launching fiber 12 coupled to pulsed laser 36. To minimize coupling losses and provide for the desired intensity of light coupled into the receiving component, GRIN lens 12 is so configured that the effective area of mode in the receiving component is small enough to cause the intensity of light to at a level sufficient to generate the nonlinearities of interest at the desired low threshold. Typically, the SPM nonlinear effect is accompanied by other nonlinear effects, such as FWM and SRS.

The augmentation of the above-discussed nonlinearities in the disclosed device utilizing HNL fibers has very important practical applications because this type of fibers combines high non-linearity with a numerically small dispersion. In particular, the devices illustrated in respective FIGS. 7-8 can be used, without any limitation, for pulse compression, parametric amplification, optical sampling, non-linear optical loop mirror optical time domain de-multiplexing, wavelength conversion, OCT and spectroscopy.

So far, the applications of the device have been associated with the augmentation of the nonlinearities of interest in a receiving component upon increasing the intensity of the field coupled into the input of this component. There are, however, multiple practical applications in which the nonlinearities of interest should be suppressed, i.e. the desired threshold for nonlinearities should be as high as possible, since, for a few exceptions including those discussed above, nonlinear effects are undesirable. Accordingly, the device associated with these applications should be configured so as to suppress nonlinearities in a receiving specialty component.

FIG. 9 illustrates a single frequency laser where raising of a threshold for nonlinearities (or suppression of nonlinearities) is desirable. The single frequency laser device typically has a seed source such as a DFB laser or external tunable laser, and a plurality of amplifying stages S₁ . . . Sn at least one of which is configured with a large mode area (LMA) fiber 44. The stages are coupled to one another through respective isolators (ISO) 42. As light propagates along the SF device, the MFD increases with each subsequent downstream stage Sn. The reason for the greater MFD is to suppress nonlinear effects, such as Stimulated Brillouin Scattering (SBS), at downstream stages in order to avoid additional losses. In other words, it is desirable that a threshold for the articulated SBS be as high as possible which is achieved by controllably increasing the effective area of the mode in a downstream receiving component in order to decrease the intensity of light therein.

Stimulated Brillouin scattering (SBS) occurs when spectral power density reaches a level sufficient to generate acoustic vibrations in the glass. This can occur at powers as low as a few milliwatts in single-mode fiber. Acoustic waves form when the optical field is intense enough to change the density of a material through the process of electrostriction, and thus alter its refractive index. The resulting refractive-index fluctuations and the resulting acoustic waves can scatter light—the phenomenon called Brillouin scattering. In fibers, SBS takes the form of a light wave shifted slightly in frequency from the original light wave and propagating in a direction opposite to the one of the light wave. This scattered light builds with fiber length extracting light from the original lightwave and, thus, limiting the amount of light in the forward direction. Accordingly, having multiple amplifying stages in a SF fiber device leads to the reduced length of fiber in each stage. The use of isolators 32 minimizes the propagation of backreflected light and, also, helps breaking the acoustic mode inside the fiber.

Typically, the first upstream stage SI is configured with a relatively small MFD so as to produce a high gain. But as the MFD becomes larger and larger with each subsequent stage, the losses tend to accumulate. To avoid forbidding coupling losses at later amplifying stages, GRIN lens 14 is coupled between at least two adjacent downstream stages. Obviously, it is highly desirable to avoid the SBS nonlinear effect in the downstream stage in order to maximize gain therein, which can be as small as about 3 dB. Accordingly, GRIN lens 14 is configured with such a mode field at the output thereof that the effective area of mode in the receiving component causes the intensity of light coupled into LMA optical component 44 of the downstream stage to decrease. As a consequence, the threshold for originating the SBS nonlinear effect in the downstream stage immediately following the GRIN lens is raised.

The LMA fibers are specialty fibers with fiber core geometries ranging from tens to hundreds and even thousands of microns. Of special interest within the context of this disclosure, is single-mode LMA fibers or those LMA fibers which are configured with a multimode core capable of supporting a single fundamental mode at the desired wavelength of optical signal. In contrast to conventional small core fibers, LMA fibers, thus, have a relatively large core and low NA. By increasing the core diameter and reducing the core NA, it is possible to maintain single mode or very few modes operation while decreasing the power density in the fiber, thereby increasing the threshold power for the nonlinear processes.

Returning to the device of FIG. 9, once the desired effective area and, therefore, intensity of light at the input of component 44 is achieved, the latter is adjusted to have its MFD match that one at the output of the GRIN lens. The LMA fibers may have a step index configuration, or refractive index profile estimated to be a step index. Alternatively, LMA fibers may be generally configured and classified as photonic crystal or holey fibers. If LMA receiving component 44, for example, has a step index profile, the modification of the core diameter and NA lead to the desired mode field matching the mode field at the output of GRIN lens 14.

FIG. 10 illustrates a further application of the disclosed device configured to lessen nonlinearities in a delivery or receiving component 50 coupled to a powerful pulsed laser 48. It is not uncommon to have a peak power of about 100 kW requiring great length of a delivery fiber. As the length of receiving component 50 increases in this type of devices and depending on a pulse format and spectral width, a plethora of nonlinear effects, such as SBS, FWM, SPM and so on, can seriously affect the operation of the device. As readily understood by one of ordinary skills in the laser arts, the nonlinear effects are extremely undesirable in pulsed lasers. Accordingly, delivery component 50 is configured as an LMA fiber with a large MFD, for example 20 mμ; in contrast, launching SM component 12 directly coupled to the output pulsed laser 48 may have as low the MFD as, for example, 14 mμ. Accordingly, the high peak pulsed laser system illustrated in FIG. 10 is further configured with GRIN lens 14 coupled to the opposing ends of launching and receiving components 12 and 50, respectively. In accordance with the basic concept of this disclosure, GRIN lens 14 is configured so that desired effective area of mode in LMA receiving component 50 provides for such a level of intensity of light coupled into the receiving component that the nonlinearities of interest are originated at a relatively high threshold at the desired wavelength.

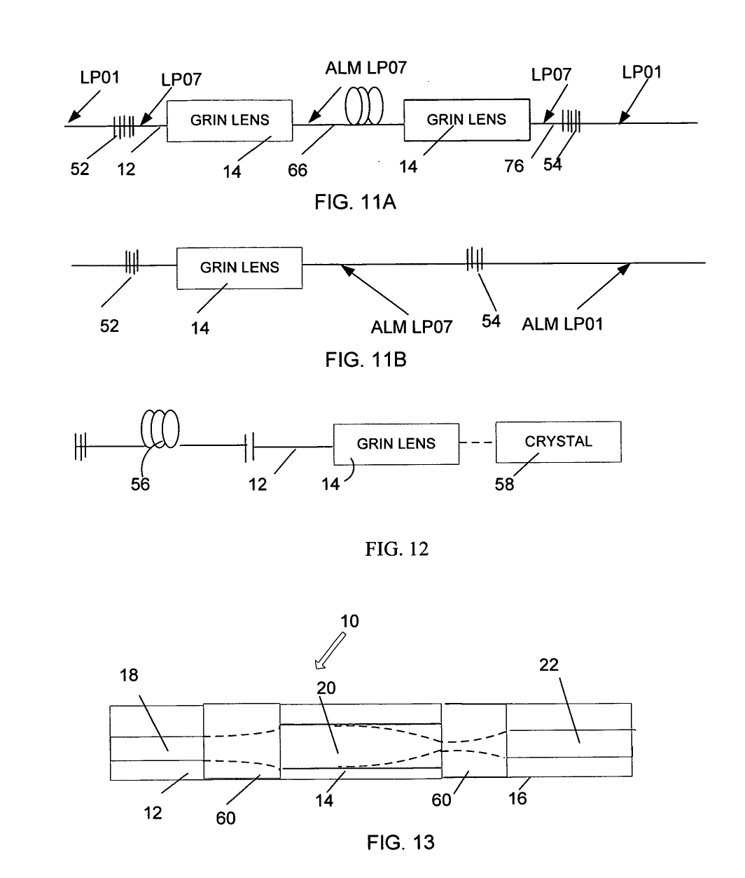

FIGS. 11A and B show still another application of the disclosed structure configured to minimize nonlinearities and thus, provided with LMA fibers. As known, it is possible to excite modes higher than a fundamental transverse mode LP₀₁ of light propagating along a fiber, which is configured to support multiple modes. The reason for operating with higher modes is to raise the threshold for nonlinearities. The higher the mode, the greater the effective area, the lower the intensity of the field, the higher the threshold for nonlinearities. Some of these higher modes, such as LP₀₇, propagate very close to the fundamental mode. The device shown in FIGS. 11A&B utilizes this concept.

In particular, the device of FIGS. 11A and 11B includes a launching component 12 capable of propagating an arbitrary fundamental mode LP₀₁. A long period fiber Bragg grating (LPFBG) 52 is written in launching component 12 and operative to excite higher-order mode, such as LP₀₇ with the desired effective area thereof of up to 350 μm². To even further decrease the intensity associated with higher-order modes, the device includes receiving LMA optical component 66 configured to support the LP₀₇ mode.

The upstream GRIN lens 14 is specifically configured so that an effective area in LMA receiving component 66 leads to the intensity of light therein which is sufficient to originate the nonlinear effects of interest at the appropriately high threshold. Upon propagation of higher mode LP₀₇ along a certain length of receiving component 66, the MFD may be reduced. Accordingly, the device of FIG. 11A has downstream receiving component 76 configured with an MFD smaller than upstream LMA receiving component 66 but still capable of supporting the propagation of higher mode LP₀₇. The receiving component 76 also may or may not be configured as an LMA fiber.

To prevent forbidden coupling losses, second GRIN lens 14 is coupled between upstream e LMA receiving component 66 and upstream and downstream receiving components 66 and 76, respectively, and configured so as to have the desired threshold for nonlinearities in downstream receiving component 76. Finally, a downstream LPFBG 54 is written in downstream receiving component 76 and configured to convert the higher mode to the fundamental mode LP₀₁. Similar to the above-disclosed applications, the receiving component may be adjusted so as to have its MFD match that one of the output of GRIN lens 14.

FIG. 11B illustrates a modification of the device of FIG. 11A which does not require neither downstream GRIN lens 14 nor receiving component 76. Instead, after propagating a certain distance along receiving LMA component 66, the light may be converted to fundamental mode LP₀₁ simply by downstream LPFBG 54, which, in this case, is written in LMA receiving component 66. Note that the higher mode LP₀₇ is disclosed only as an example, and other higher modes can be dealt with in the same manner as the disclosed one.

FIG. 12 illustrates the disclosed device having receiving component 16 which is crystal such as LBO, BBO, KDP, BIBO, LiNO₃ and others. The use of the crystal-configured receiving component allows for the exploitation of such nonlinear effects as the second harmonic generation (SHG). The SHG is the non-linear effect whereby two incident photons from an intense laser pass through a polarisable material and are changed by the sample under investigation into one photon that emerges with double the incident energy and frequency. In this application, like in others, GRIN lens 14 is configured with the desired level of intensity at its output while providing substantially lossless coupling between a laser 56, which is provided with launching component 12, and a microchip crystal or receiving component 58.

So far, all of the above disclosed applications of the disclosed concept have been based on the fact that GRIN lens 14 of the optical waveguide has a specific length L between two planar wavefronts R₁ and R₂ (FIG. 2). In other words, each specific configuration of GRIN lens 14 provides for a fixed relationship between the flat wavefronts thereof. As a consequence, the manufacturing of lens 14 provided with specific parameters may be cumbersome when a number of different MFDs at the output or input are required. As disclosed hereinbelow in reference to FIG. 13, the GRIN lens may not be appropriately made, i.e., the opposite ends of the GRIN lens may not correspond to the respective flat wavefronts. In other words, the intensity of light coupled into receiving component 16 may not be appropriate for inducing the nonlinear effect(s) of interest at the desired threshold.

FIG. 13 illustrates a further technique for controllably developing the focusing component so that the intensity of light at the input of receiving component 16 is sufficient to cause the selected non-linear effects at the desired threshold in this component. However, the focusing component is so configured, as disclosed below, that the desired threshold of nonlinearities in receiving component 16 is reached.

This is attained by configuring the focusing component with GRIN lens 14 and a spacer 60—passive coreless pure-silica fiber. As disclosed by A. D. Yablon et al.⁴, which is fully incorporated herein by reference, the use of such a spacer provides for expanding or diverging the mode field. As readily realized by one of ordinary skills in the optical arts, the expansion of the optical beam through the silica medium is a result of the diffraction of light wave in the coreless pure-silica fiber. ⁴ “Low-Loss High-Strength Microstructured Fiber Fusion Splices Using GRIN Fiber lenses”, 2004 Optical Society of America.

Referring to FIG. 2 in addition to FIG. 13, let's assume, for example, that light propagates in a direction Lpd (FIG. 2) and further that the waist “w” at the output of GRIN lens 14 is too small. In this case, the intensity of light coupled into receiving component 16 is somewhat high for originating the nonlinearities of interest at the desired threshold. To still obtain the desired threshold for nonlinearities while leaving the GRIN lens intact, the focusing component has spacer 60 fused to the output of GRIN lens 14. As the light is coupled into spacer 60, the mode field begins to diverge. As a result, the waist W at the output of the focusing component is greater than in case of single GRIN lens 14. The greater the waist, the greater effective area, the smaller the intensity of light in receiving component 16. As a consequence, the device of FIG. 13 with spacer 60, fused to the output end of GRIN lens 14 and receiving component 16, allows for the weakened nonlinearities in the latter.

Other possibilities based on the teaching of the incorporated references can present themselves in case of two spacers 60 fused to the opposite ends of GRIN lens 14. Using a two-spacer structure, for example, it is possible to configure such a device that the desired threshold for nonlinearities in receiving component would be augmented.

Up until now the discussion has been related to a GRIN lens configured with a parabolic refractive index. However, there is still a further technique allowing to controllably develop GRIN lens 14 with the desired parameters. In particular, the use of well known numerical routines, such as finite distance beam propagation (FD-BPM) and others, allows for controllably tweaking the GRIN lens refractive index profile different from the parabolic so as to have such a mode field at the output of GRIN lens 14 that the effective area of mode in receiving component 16 and, thus, the intensity of light originate selected non-linear effect(s) at the desired threshold.

Although shown and disclosed is what is believed to be the most practical and preferred embodiments, it is apparent that departures from the disclosed configurations and methods will suggest themselves to those skilled in the art and may be used without departing from the spirit and scope of the invention. For example, while the above description is based on propagation of a beam light from an optical component with a larger MFD to a component with a smaller MFD, the opposite direction of propagation is, of course, possible due to the inherent structure of the disclosed optical components. Furthermore, both the launching and receiving components can be made from the fiber known as Panda if polarization is desired. The non-linear effects are not limited to those disclosed above, but may include others. Accordingly, the present invention is not restricted to the particular constructions described and illustrated, but should be construed to cohere with all modifications that may fall within the scope of the appended claims.

1. An optical system, comprising:
a focusing component transmitting a beam of light propagating at a fixed power; and
a receiving component substantially losslessly coupled to an output of the focusing component, wherein the focusing component is configured so that an effective area of a mode in the receiving component induces at least one nonlinear effect therein at a predetermined threshold at the fixed power.

2. The optical system of claim 1, wherein the receiving component is made from a specialty fiber configured with a mode field diameter matching a mode field diameter at the output of the focusing component.

3. The optical system of claim 1, wherein the receiving component is made from a crystal.

4. The optical system of claim 1, wherein the focusing component comprises a graded index (GRIN) lens with a core thereof controllably adjusted to indirectly induce the at least one nonlinear effect at the desired threshold.

5. The optical system of claim 1, wherein the focusing component comprises a graded index (GRIN) lens with a numerical aperture (NA) adjusted so as to indirectly induce the at least one nonlinear effect in the receiving component at the desired threshold.

6. The optical system of claim 1, wherein the beam propagates at a wavelength selected to indirectly induce the at least one nonlinear effect in the receiving component at the desired threshold.

7. The optical system of claim 4, wherein the GRIN lens is configured with a refractive index profile selected from the group consisting of a parabolic refractive index profile and non-parabolic refractive index profile, the refractive index profile being determined so as to induce the at least one nonlinear effect in the receiving component at the desired threshold.

8. The optical system of claim 4, wherein the focusing component further includes at least one coreless waveguide coupled to the output end of the GRIN lens and configured so as to induce the at least one nonlinear effect in the receiving component at the desired threshold.

9. The optical system of claim 8, wherein the focusing component includes two coreless waveguides coupled to respective opposite output and input ends of the GRIN lens.

10. The optical system of claim 4 further comprising a light launching component radiating the beam of light at the fixed power and substantially losslessly coupled to an input end of the focusing component, the launching component being configured with a predetermined spectral and temporal performance.

11. The optical system of claim 2, wherein the specialty fiber is a single mode or multimode fiber selected from the group consisting of a large mode area (LMA) fiber and highly nonlinear (HNL) fiber, the LMA and HNL fibers each having a host material selected from silica fibers or non-silica fibers, the silica-configured fiber being selected from the group consisting of substantially step-index-configured fibers and photonic crystal fibers, the non-silica fiber being selected from the group consisting of bismuth-based, telluride-based and fluoride-based fibers.

12. The optical system of claim 3, wherein the crystal is selected from the group consisting of LBO, BBO, KDP, BIBO, LiNO₃.

13. The optical system of claim 1, wherein the at least one nonlinear effect is selected from a group consisting of stimulated Raman scattering, four wave modulation, self phase modulation, stimulated brillouin scattering, second harmonic generation and a combination of these.

14. A method of controllably originating at least one nonlinear effect in a receiving optical component comprising the steps of:
configuring a focusing component transmitting a beam of light at a fixed power and coupled to the receiving component so that an effective area of a mode in the receiving component induces the at least one nonlinear effect at a desired threshold.

15. The method of claim 14, wherein the coupling component includes at least one graded-index (GRIN) lens.

16. The method of claim 15, wherein inducing the at least one nonlinear effect at the desired threshold in the receiving component comprises a step selected from the group consisting of:
adjusting a core of the GRIN lens;
adjusting a numerical aperture of the GRIN lens;
selecting a wavelength of the beam;
selecting a refractive index profile of the GRIN lens; and
a combination of these.

17. The method of claim 15, wherein the focusing component further comprises a coreless waveguide coupled to at least one of input and output ends of the GRIN lens so that the effective area of the mode in the receiving component induces the at least one nonlinear effect at the desired threshold.

18. The method of claim 14 further comprising providing a launching component radiating the beam of light at the fixed power and having a predetermined output termination, spectral and temporal performances, and substantially losslessly coupled to an input of the focusing component, wherein the focusing component is configured so that a mode field diameter at an output of the focusing component matches a mode field diameter at an input of the receiving component.

19. An optical system, comprising:
a laser device radiating a beam of light propagating along a laser output fiber at a fixed power;
a highly nonlinear (HNL) component receiving the beam; and
at least one focusing component having input and output ends coupled to the laser output fiber and HNL receiving component, respectively, wherein the focusing component is so configured that an effective area of a mode at an input of the receiving component induces at least one nonlinear effect in the HNL receiving component at a desired threshold.

20. The optical system of claim 19, wherein the laser device is configured as a continuous wave laser device or a pulsed laser device, the at least one focusing component including a graded-index (GRIN) lens, the HNL receiving component being a passive Raman fiber.

21. The optical system of claim 19, wherein at least one nonlinear effect is selected from the group consisting of a stimulated Raman scattering, Four Wave Mixing, Self-Phase modulation and a combination of these.

22. The optical system of claim 19, wherein the focusing component includes a plurality of consecutive graded-index (GRIN) lenses configured so that the effective area of the mode induces the at least one nonlinearity at the desired threshold.

23. The optical system of claim 20, wherein the focusing component further includes one or a plurality of coreless pure silica fibers coupled to the GRIN lens and configured so that the effective area of the mode in the HNL receiving component induces the at least one nonlinear effect at the desired threshold therein.

24. An optical system, comprising:
a laser device radiating a beam of light propagating along a laser output fiber;
at least one large-mode area (LMA) fiber receiving the beam; and
at least one focusing component having input and output ends coupled to the laser output and LMA receiving fibers, respectively, wherein the focusing component is configured so that an effective area of a mode in the receiving component induces at least one nonlinear effect in the LMA receiving fiber at a desired threshold.

25. The optical system of claim 24, wherein the laser device is configured as a high peak pulsed laser, the focusing component including at least one GRIN lens.

26. The optical system of claim 24, wherein the effective area is determined to induce multiple nonlinear effects each selected from the group consisting of stimulated Brilluoin scattering, self phase modulation, and four wave mixing.

27. The optical system of 24 further comprising
a booster optically coupled to an input of the at least one LMA fiber;
a series of additional LMA fibers optically coupled to an output of the at least one LMA fiber, each subsequent LMA fiber having a mode field diameter (MFD) larger than that one of a previous LMA fiber, wherein the booster and the LMA fibers are arranged to define a single frequency laser device, and
a plurality of additional focusing components each located between adjacent LMA fibers and configured so that the effective area of the mode at an input of an utmost downstream LMA receiving fiber induces the at least one non-linear effect at the desired threshold.

28. The optical system of claim 24 further comprising:
an upstream long period fiber Bragg grating written in the output fiber and operative to excite a second mode higher than the mode, wherein the mode being a fundamental mode.

29. The optical system of claim 28 further comprising a downstream long period fiber Bragg grating written in the LMA receiving fiber having the effective of at most 350 μm² and capable of supporting multiple modes, wherein the downstream long period Bragg grating is configured to convert the higher mode to the fundamental mode.

30. The optical system of claim 28 further comprising:
a downstream fiber capable of supporting the higher mode and configured with a mode field diameter smaller than that one of the LMA fiber;
a downstream focusing component between the one LMA and downstream fibers, the downstream focusing component being configured so that the optical signal propagates substantially losslessly from the LMA to the downstream fiber; and
a downstream long period fiber Bragg grating written in the downstream fiber and configured to convert the higher mode to the fundamental mode.
